(19) United States
(12) Patent Application Publication
(10) Pub. No.: US 2007/0188754 A1
(43) Pub. Date: Aug. 16, 2007

(54) LASER SCANNING MICROSCOPE WITH SPECTRALLY RESOLVING RADIATION DETECTION

(75) Inventors: Gunter Moehler, Jena (DE); Ralf Engelmann, Jena (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Carl Zeiss Microlmaging GmbH

(21) Appl. No.: 11/672,774

(22) Filed: Feb. 8, 2007

(30) Foreign Application Priority Data
Feb. 10, 2006 (DE) 10 2006 006 277.9

(51) Int. Cl. G01J 3/28

(52) U.S. Cl. 356/328

(57) ABSTRACT

The invention is directed to a laser scanning microscope with a detector device for spectrally resolving radiation detection. The detector device has at least one dispersive element, on which a beam of the radiation to be detected impinges and which fans out this beam spectrally, and at least two detector line arrays to which the spectrally fanned out radiation is directed and whose sensitivity is only adjustable in a unitary manner. At least two detector line arrays are provided in the detector device, each of them being irradiated by spectrally fanned out radiation of different spectral composition. The respective spectral composition of the radiation and the basic spectral sensitivity of the detector line arrays are taken into account in the sensitivity adjustment of the detector line arrays.

### CROSS-REFERENCE TO RELATED APPLICATION

This application claims priority of German Application No. 10 2006 006 277.9, filed Feb. 10, 2006, the complete disclosure of which is hereby incorporated by reference.

### BACKGROUND OF THE INVENTION

a) Field of the Invention

The invention is directed to a laser scanning microscope with a detector device for spectrally resolving radiation detection, wherein the detector device has at least one dispersive element, on which a beam of the radiation to be detected impinges and which fans out this beam spectrally, and a detector line array to which the spectrally fanned out radiation is directed and whose sensitivity is only adjustable in a unitary manner. The invention is further directed to a method for spectrally resolved detection of radiation in a microscope, wherein a beam of the radiation to be detected is spectrally fanned out to a beam bundle and is directed to a detector line array whose sensitivity is only adjustable in a unitary manner.

b) Description of the Related Art

It is known from the prior art for a laser scanning microscope to achieve spectrally resolving radiation detection in that a beam with the radiation to be detected is spectrally fanned out by means of a dispersive element into a divergent beam bundle and is then detected by a detector line array. This is described, for example, in DE 10340020 B4 which discloses a device and a method of the type mentioned above. The same is found in DE 10102033 A1 and in the LSM 510 META laser scanning microscope marketed by Carl Zeiss Jena GmbH.

When the spectral fanning out, i.e., the specifications of the dispersive element, are not changed, the same spectral detection of the radiation is obtained with each recording. The spectral sensitivity is substantially predetermined by the sensitivity of the detector line array. Therefore, laser scanning microscopy currently relies on photomultiplier arrays (PMT) because they enable an optimal intensity sensitivity and, therefore, a good spectral analysis. The detection limit for individual spectral components is predetermined by the sensitivity of the detector line array, i.e., of the photomultiplier array. As is well known, the basic sensitivity of photomultiplier arrays can be adapted by presetting a high voltage as operating voltage. When the high voltage is increased, the radiation sensitivity of the entire PMT array is increased. However, it is not possible to increase the high voltage to any desired extent because otherwise individual elements of the detector line array would operate outside of their linear operating range. Accordingly, with photomultiplier arrays, the detection limit for individual spectral components is ultimately determined by the linear operating range and the maximum intensity of the brightest spectral line in the radiation to be detected.

Up to a certain degree, the linearity range can be exploited in an improved manner by eliminating unwanted spectral regions from the spectrally fanned out beam bundle before they impinge on the detector line array. This approach is pursued in the LSM 510 META microscope as well as in DE 10340020 B4 and is used to suppress exciting spectral lines in fluorescence microscopy. However, there remains the problem that the detection limit for spectral components is determined by the linearity range of the detector line arrays, i.e., of the photomultiplier arrays.

### OBJECT AND SUMMARY OF THE INVENTION

It is the primary object of the invention to further develop a device and a method of the type mentioned in the beginning in such a way that an improved intensity resolution is achieved for weak spectral lines in a given linearity range of the detector line array.

This object is met according to the invention by a device of the type mentioned in the beginning in which the detector device is provided with at least two detector line arrays which are irradiated by spectrally fanned out radiation of different spectral composition, wherein the respective spectral composition of the radiation and the respective basic spectral sensitivity of the detector line array are taken into account in the sensitivity adjustment of the detector line arrays. The solution according to the invention further provides a method of the type mentioned in the beginning in which at least two detector line arrays are used, whose sensitivity is adjusted by taking into account the respective spectral composition of the radiation and of the respective basic spectral sensitivity of the detector line array.

The invention proceeds from the insight, not addressed heretofore in the prior art, that by distributing the spectrally fanned out radiation to two detector line arrays each detector line array can be adapted in an optimal manner to the intensity distribution in the respective spectrally fanned out beam bundle with respect to its basic sensitivity, which is only adjustable in a unitary manner, and therefore with respect to its linearity range. Accordingly, it is now possible to make use of a characteristic of current photomultiplier arrays which until now has had disadvantageous effects in other respects. In particular, photomultiplier arrays, like other detector line arrays, have a spectrally-dependent basic sensitivity which is usually determined by a scintillator layer arranged in front of the individual photomultipliers. This scintillator layer which is required in photomultiplier arrays for reasons having to do with the system converts the incident photons into electrons which are then detected by the individual photomultipliers. A quantum yield (or photon yield) acting as conversion factor depends upon the photon frequency, i.e., on the wavelength of the incident radiation. As a result of the spectrally-dependent basic sensitivity, individual spectral components with a higher intensity than others were detected in the prior art even in spectrally fanned out white light, i.e., radiation in which all spectral components are distributed approximately equally. Therefore, the spectral components which are detected with higher photon yields naturally present an upper limit for the linear operating range relatively quickly. The concept according to the invention allows different spectral or spectrally-independent basic sensitivities, e.g., scintillator layers and/or high-voltage adjustments, to be used for the individual detector line arrays so that the linear operating range is additionally expanded.

Therefore, in a preferred construction of the invention, each detector line array has a scintillator layer with photomultiplier elements arranged downstream, wherein the scintillator layers of the detector line arrays differ with respect to their spectral sensitivity. In an analogous manner, it is preferable for the method that photomultiplier arrays which each have a scintillator layer are used for the detector line arrays, and the spectral sensitivity of the scintillator layers is selected differently.

The plurality of detector line arrays can now be used in two different ways in principle. First, the detector line arrays can be arranged downstream of a shared dispersive element. The detector line arrays then lie next to one another in the fanned out beam bundle Alternatively, it is possible to generate a plurality of spectrally fanned out beam bundles in which one or more detector line arrays are arranged, wherein the spectral fanning out differs in the individual bundles. The fanning out is preferably selected in such a way that the spectral regions of the individual bundles adjoin one another. Naturally, a detector line array or two, three or four (or even more) detector line arrays situated next to one another can be used in each bundle.

In addition to the expansion of the linearity range with the detector line array characteristics remaining the same, the invention also makes it possible to increase the detected spectral region or the spectral resolution beyond the known extent. The selected spectral region can be between 350 nm and 1000 nm, and the spectral resolution, i.e., the spectral region detected by the individual elements of the detector line arrays, can be between 1 nm and 100 nm, preferably between 20 nm and 50 nm, ideally between 30 nm and 40 nm.

The invention makes it possible to carry out a different sensitivity adjustment in separate spectral regions with commercially available detector line arrays whose basic sensitivity is only adjustable in a unitary manner, e.g., by presetting the high voltage. Accordingly, not only can the linearity range be increased, but an improved uniformity of the spectral sensitivity beyond the detected spectral region can be achieved because the individual detector line arrays are outfitted with different spectral sensitivity and/or a variable spectral sensitivity can be compensated by corresponding amplification adjustment. PMT line arrays are indicated herein as an example of high-voltage detector line arrays having the characteristics that the basic sensitivity can be adjusted in operation, but only in a unitary manner for the entire line and not for the cells individually. Further, by detector line array is meant a detecting element for radiation which has 2 to n individual cells arrayed in a line, each of which detects radiation and emits a corresponding signal, wherein the individual cells can be adjusted only in a unitary manner with respect to their basic sensitivity. The individual cells are combined in a structural component part and are usually produced on a shared substrate because semiconductor fabrication is advantageously used for cost-related reasons.

The individual elements can be read out independently in principle. Therefore, as an independent implementation under certain circumstances, two or more individual elements which can lie in one or more detector lines are combined with respect to the signal readout. This reduces the costs relating to evaluation to the spectral channels that are actually needed.

Accordingly, a substantial advantage of the invention consists in that commercially available detector line arrays, e.g., in the form of PMTs, can be retained while still achieving an improved spectral detection power. Special detector lines which are laborious to produce and therefore costly are unnecessary.

The invention will be described more fully in the following by way of example with reference to the drawing.

### BRIEF DESCRIPTION OF THE DRAWINGS

In the drawings:

FIG. 1 shows a microscope with a detector module according to a first embodiment form of the invention;

FIG. 2 shows a microscope with a detector module according to a second embodiment form;

FIG. 3 shows different sensitivity curves for detector line arrays which can be applied in the embodiment forms according to FIG. 1 or FIG. 2;

FIG. 4 shows details of the connection of the detector line arrays schematically; and

FIG. 5 shows a microscope with a detector module according to the prior art.

### DESCRIPTION OF THE PREFERRED EMBODIMENTS

Before discussing the invention, a microscope M with a detector module 1 according to the prior art will be explained with reference to FIG. 5 for purposes of illustration. The detector module 1 makes use of the principle realized in the LSM 510 META by Carl Zeiss Jena GmbH. The radiation to be detected in the microscope M is in the form of a beam 2 and is spectrally divided by a grating 3 into a beam fan 4 presenting a divergent beam bundle. The beams of the fan 4 have different spectral compositions depending on the angle relative to the optical axis of the incident beam 2.

A PMT line 5 serving as a detector line array is placed in the fan 4. The line 5 is supplied with operating voltage by an electronics module 6, and the values measured by the line 5 are read out by the electronics module 6. The electronics module 6 is connected in turn to a control device 7 which, in the microscope M, controls at least the operation of the detector module 1 which collects corresponding measured values and provides them to other units if required.

The PMT line 5 has individual PMT cells 8 which operate according to the known photomultiplier principle, and a shared scintillator layer 9 is arranged upstream of the latter. The scintillator layer 9 converts the photons of the fan 4 into electrons which are detected by the PMT cells 8. The electron amplification taking place for detection is adjusted by a high voltage which is determined by the electronics module 6 and can be supplied to the PMT line 5 only in a unitary manner. An individual adjustment of the amplification and therefore of the detection sensitivity of the PMT cells 8 is not possible on principle. This applies to a large number of detector line arrays for which a PMT line is used herein by way of example.

In the microscope according to the prior art, the control device 7 adjusts the amplification caused by the electronics module 6 through the high-voltage adjustment, that is, in such a way that the corresponding PMT cell 8 is just below saturation at the most intensive spectral line impinging on the PMT line 5. The detection limit for weak spectral components in the fan 4 is predetermined in this way.

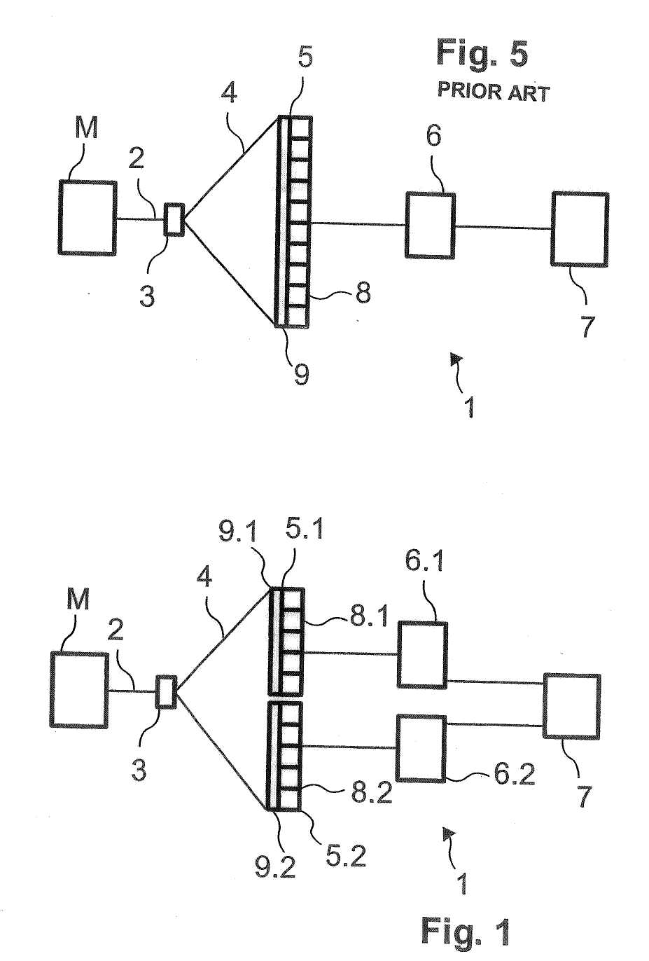

The detector module 1 of the microscope M according to the invention is shown schematically in FIG. 1 and differs from the detector module 1 of FIG. 5 in that a plurality of PMT lines 5 are provided. The plurality of corresponding structural component parts shown in FIG. 1 have the same reference numbers as in FIG. 4 but supplemented by “0.1” and “0.2”. Structural component parts having the same function also have the same reference numbers as in FIG. 5 and need not be described in greater detail. In the detector module 1 in FIG. 1, two PMT lines 5.1 and 5.2 lie next to one another in the fan 4. They have half the number of PMT cells 8.1 and 8.2 compared to the PMT line 5 shown in FIG. 5 so that the detected spectral band and the achieved spectral resolution remain the same as a whole. The gap shown in FIG. 1 between the PMT lines 5.1 and 5.2 serves merely to illustrate and distinguish the detector line arrays. Actually, the detector line arrays adjoin one another as seamlessly as possible.

Each detector line array in the detector module 1 of FIG. 1 is connected to its own electronics module 6.1 and 6.2, respectively, so that the amplification is adjusted individually for the detector line arrays (again, naturally, only in a unitary manner for each detector line array). For this purpose, the control device 7 evaluates, for example, the brightest spectral lines and adjusts the amplification by means of the high-voltage preset of the respective electronics module 6.1 and 6.2.

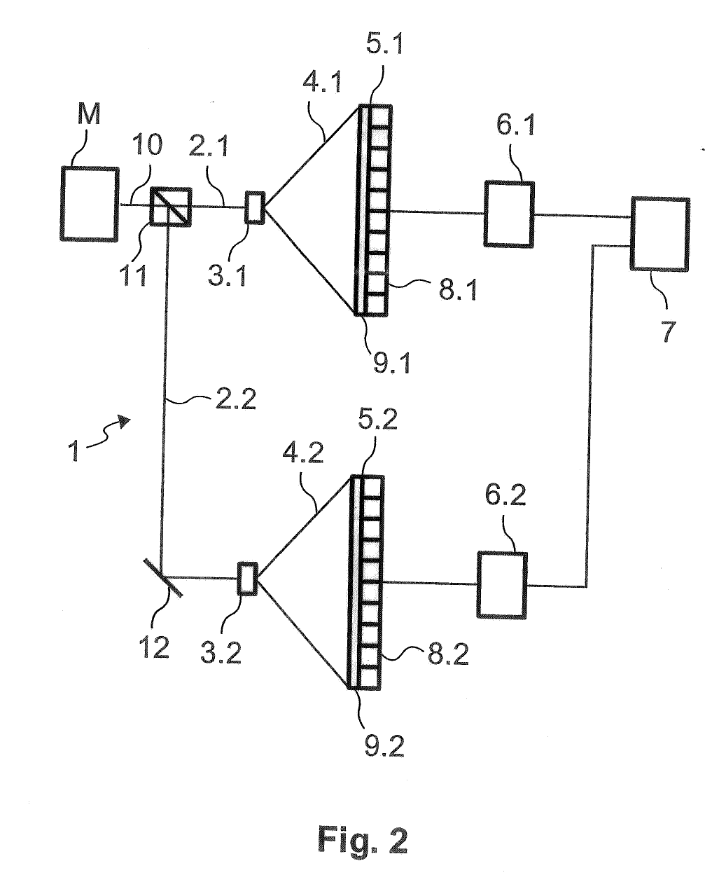

FIG. 2 shows an alternative mode of construction. In this case, the beam 10 of the microscope M to be detected is initially divided by a beamsplitter 11 so that it impinges on a grating 3.1 and 3.2, respectively, as beam 2.1 and beam 2.2, respectively (the latter impinges, as the case may be, with the intermediary of a deflecting mirror 12). Each grating again generates a beam fan 4.1 and 4.2, respectively, which is directed to a PMT line 5.1 and 5.2, respectively, supplied by an electronics module 6.1 and 6.2, respectively. Accordingly, in contrast to the mode of construction according to FIG. 1, two spectrally fanned out beam bundles are generated in the form of fans 4.1 and 4.2 in the variant shown in FIG. 2 so that the detected spectral region or the achieved resolution is doubled compared to the construction shown in FIG. 1 when the quantity of individual elements of the detector line arrays remains the same as in the construction according to FIG. 4. The disadvantage of this construction consists in that the beam 10 to be detected must initially be divided by a beamsplitter 11 which naturally results in a certain loss of intensity in the beams 2.1 and 2.2 impinging on the gratings 3.1 and 3.2. The use of a suitable dichroic beamsplitter can prevent or compensate for this to a certain degree.

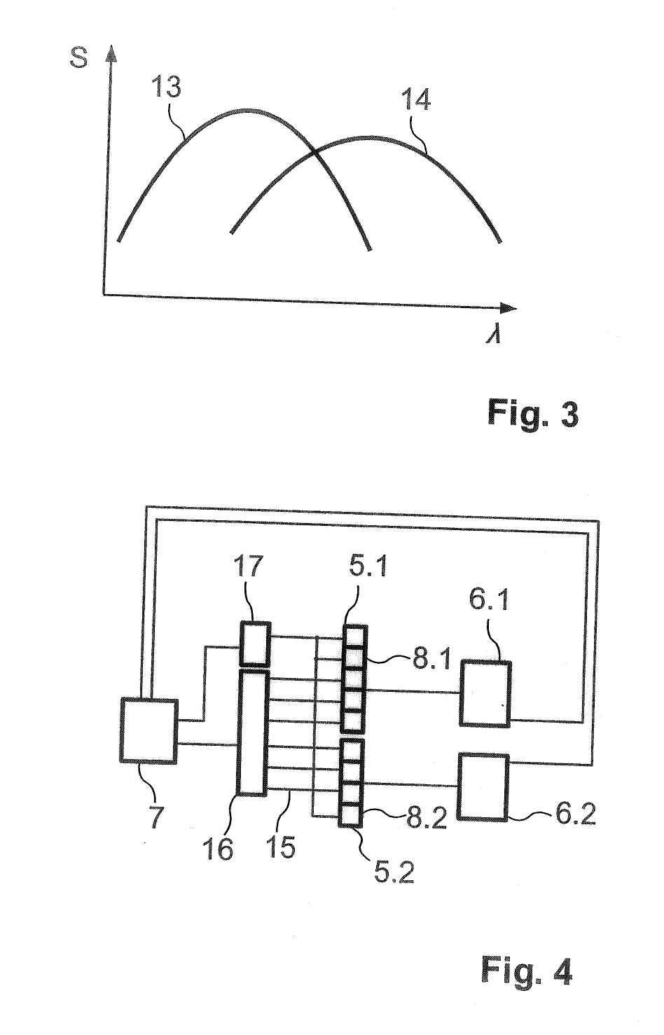

In the construction modes shown in FIGS. 1 and 2, a basic spectral sensitivity which is adapted to the spectral region impinging on the respective detector line array can be selected in the scintillator layers 9.1 and 9.2. Two sensitivity curves 13 and 14 are shown by way of example and in a highly simplified manner in FIG. 3 for different scintillator materials which, depending on the wavelength λ, have a different spectral sensitivity S, i.e., they convert incident photons with spectrally dependent quantum yields into electrons. On one hand, the use of at least two detector line arrays makes it possible to provide the detector line arrays with a scintillator material which delivers optimal quantum yields for the respective partial) spectral region. On the other hand, a different quantum yield in the spectral region impinging on the detector line array 5.1 and 5.2, respectively, can be compensated in an improved manner by adjusting the amplification.

FIG. 4 shows that the signal readout in the detector line arrays need not take into account the distribution of the individual cells 8.1 and 8.2, respectively, on the two detector line arrays. The two or more detector line arrays are separate with respect to the adjustment of the basic sensitivity, i.e., with respect to the electronics modules 6 in the present embodiment example. However, FIG. 4 shows that the cells 8.1 and 8.2 can be combined in any desired manner for each detector line array with respect to the signal taken off and the signal evaluation. In the example shown in FIG. 4, three PMT cells lying near the edge in the spectral fan 4 are combined. Each individual cell 8.1 and 8.2 is connected to an evaluation circuit by an evaluation line 15. The rest of the cells are read out by a first evaluation circuit 16 and the cells close to the edge are read out by a second evaluation circuit 17. Accordingly, the two evaluation circuits detect individual cells from the two detector line arrays. Further, each evaluation circuit 16, 17 is connected to the control device 7 which accordingly receives evaluation signals proper to the individual cells that are read out individually and a joint evaluation signal for the combined individual cells. The combination of individual cells is not limited to cells close to the edge; any combinations are possible. Also, the combination need not be carried out by electrical connection as is shown schematically in FIG. 5, but can also be carried out in the respective evaluation circuit by signal processing.

The evaluation-oriented combination of individual cells has the advantage that spectral regions which must be distinguished from one another in the light beam to be detected but which are significant for image acquisition can easily be detected in a summed manner without unnecessary cost. The number of spectral channels is then limited to that required by the application. When this principle is applied to the use, according to the invention, of a plurality of detector lines as is shown in FIG. 4, the combined spectral channels, i.e., the individual channels which are connected together with respect to evaluation can be distributed to the detector line arrays in any desired manner as is illustrated by FIG. 4 using the example of the second evaluation circuit 17. In this respect, it is advisable always to combine those individual cells obtaining spectral components in the fan 4 which need not be distinguished individually.

It is advantageous particularly with PMT lines when the combined individual cells are combined not only with a view to their signal evaluation but also with respect to the control, which can be relatively costly in PMT cells and also time-critical with fast readouts. The combination then reduces in particular the time requirement to be adhered to for fast operation.

Finally, FIG. 4 shows in addition, by way of example, that generally speaking the plurality of detector line arrays can contain a different number of individual cells. It is essential only that detector line arrays are used in the manner indicated in the beginning because an aggregation of individual receivers involves a much higher expenditure comparatively in particular with respect to alignment.

While the foregoing description and drawings represent the present invention, it will be obvious to those skilled in the art that various changes may be made therein without departing from the true spirit and scope of the present invention.

What is claimed is:

1. A laser scanning microscope with a detector device for spectrally resolving radiation detection, said detector device comprising:
at least one dispersive element, on which a beam of the radiation to be detected impinges and which fans out this beam spectrally; and
at least two detector line arrays to which the spectrally fanned out radiation is directed and whose sensitivity is only adjustable in a unitary manner and which is irradiated by spectrally fanned out radiation of different spectral composition;
wherein the respective spectral composition of the radiation and the respective basic spectral sensitivity of the detector line arrays are taken into account in the sensitivity adjustment of each detector line array.

2. The microscope according to claim 1, wherein the at least two detector line arrays are arranged downstream of a shared dispersive element.

3. The microscope according to claim 1, wherein a plurality of dispersive elements are provided and the beam that is divided beforehand impinges thereon, the plurality of dispersive elements acting upon at least one detector line array in each instance with radiation that is spectrally fanned out differently.

4. The microscope according to according to claim 1, wherein the spectral region detected by the individual elements of the detector line arrays is between 1 nm and 100 nm.

5. The microscope according to according to claim 4, wherein the spectral region detected by the individual elements of the detector line arrays is between 20 nm and 50 nm.

6. The microscope according to according to claim 1, wherein each detector line array has a scintillator layer with individual photomultiplier elements arranged downstream, wherein the scintillator layers of the detector line arrays differ with respect to their spectral sensitivity.

7. The microscope according to according to claim 1, wherein each detector line array is connected to its own operating circuit which carries out the sensitivity adjustment.

8. The microscope according to claim 7, wherein operating circuits are connected to a control device of the microscope which sends control signals to the operating circuits and receives detection signals of the detector line arrays and individually adjusts the sensitivity of the detector line arrays by the control signals taking into account the most intensive spectral region of the detection signals.

9. A method for spectrally resolved detection of radiation in a microscope, wherein a beam of the radiation to be detected is spectrally fanned out to at least one beam bundle and is directed to at least two detector line arrays whose sensitivity is only adjustable in a unitary manner, wherein the sensitivity of each detector line array is adjusted taking into account the respective spectral composition of the radiation and the basic spectral sensitivity of the detector line arrays.

10. The method according to claim 9, wherein at least two detector line arrays detect the radiation of a spectrally fanned out beam bundle.

11. The method according to claim 9, wherein a plurality of spectrally fanned out beam bundles are used, each of them acting upon a detector line array.

12. The method according to claim 9, wherein photomultiplier arrays which each have a scintillator layer are used for the detector line arrays, wherein the spectral sensitivity of the scintillator layers is selected differently.
